(19) United States
(12) Patent Application Publication
(10) Pub. No.: US 2006/0182199 A1
(43) Pub. Date: Aug. 17, 2006

(54) Apparatus and method for retransmitting data in a communication system

(75) Inventors: Sung-Kwon Hong, Seoul (KR); Seok-Hyun Yoon, Suwon-si (KR); Dong-Seek Park, Yongin-si (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/355,269

(22) Filed: Feb. 15, 2006

(30) Foreign Application Priority Data
Feb. 16, 2005 (KR) 2005-12803

(51) Int. Cl. H04L 27/04; H04B 7/10

(52) U.S. Cl. 375/299; 375/347

(57) ABSTRACT

A communication system includes a transmitter and a receiver. If there is information data to transmit to the receiver, the transmitter generates a first transmission frame by signal-mapping the information data according to a first signal point mapping rule, and transmits the first transmission frame to the receiver. Upon receiving from the receiver a notification indicating a failure to normally receive the first transmission frame, the transmitter generates a second transmission frame by signal-mapping the information data according to a second signal point mapping rule preset such that a minimum squared Euclidean distance with the first transmission frame is maximized, and transmits the second frame to the receiver.

### PRIORITY

This application claims the benefit under 35 U.S.C. § 119(a) of an application entitled “Apparatus and Method for Retransmitting Data in a Communication System” filed in the Korean Intellectual Property Office on Feb. 16, 2005 and assigned Serial No. 2005-12803, the entire contents of which are incorporated herein by reference.

### BACKGROUND OF THE INVENTION

1. Field of the Invention

The present invention relates generally to a data retransmission apparatus and method for a communication system, and in particular, to an apparatus and method for retransmitting data in a Space-Time Block Code (STBC)-based Multiple Input Multiple Output (MIMO) communication system (hereinafter STBC-MIMO communication system).

2. Description of the Related Art

The key concern in communications is the efficiency and reliability of the transmission of data over a channel. Since research is currently underway on the next generation multimedia mobile communication system, which requires a high-speed communication system capable of transmitting such information as image, radio and voice data, there is a need to increase system efficiency using an appropriate channel coding scheme.

However, during data transmission, inevitable errors occur due to noise, interference and fading according to channel conditions, causing a loss of information. Generally, various error control schemes are used to reduce the loss of information according to channel characteristics, thereby increasing system reliability. A scheme using error correction codes is one of the most basic error control schemes. For the sake of convenience, the scheme using error correction codes will herein be referred to as a Forward Error Correction (FEC) scheme. Typical error correction codes include turbo codes and low-density parity check (LDPC) codes.

The error control schemes include an Automatic Retransmission reQuest (ARQ) scheme in addition to the FEC scheme, and the ARQ scheme can achieve high reliability with a simple structure. The FEC scheme corrects an error in received information using a code having an error correction capability, and is used when there is no feedback channel used by a receiver to transmit, to a transmitter, information indicating whether it has successfully received the information transmitted by the transmitter. However, because the use of the FEC scheme is inconsistent with the feedback channel, received information that fails in error correction is transmitted intact, causing performance degradation. On the contrary, the ARQ scheme uses Cyclic Redundancy Check (CRC) codes having high error detection capability, wherein upon detecting an error in received information, a receiver sends a request for retransmission of the defective information to a transmitter.

A comparison will now be made between the FEC scheme and the ARQ scheme.

The ARQ scheme, though it has a simple structure and high reliability, suffers a drastic reduction in information throughput at a high channel error rate. On the contrary, the FEC scheme, though it secures constant information throughput regardless of the channel error rate, has the following two problems.

First, the FEC scheme delivers received data to a user even when the data contains an error. Because the probability that the received data will show an undetectable error pattern is lower than the probability that the received data will have a detectable-but-uncorrectable error pattern, it is difficult to guarantee high reliability using only the FEC scheme. Second, a system implemented to ensure high reliability using the FEC scheme must use powerful codes that can correct various types of errors. Powerful codes have a long code length, and the increase in the code length causes undesirable decoding complexity.

Overall, in a channel environment with a high channel error rate, it is preferable to control errors using the ARQ scheme. However, the ARQ scheme cannot be used when there is no feedback channel between a transmitter and a receiver.

Therefore, a Hybrid Automatic Retransmission reQuest (HARQ) scheme has been proposed having advantages of both the ARQ scheme and the FEC scheme. The HARQ scheme corrects a frequently generated error pattern using the FEC scheme to reduce the number of retransmissions (hereinafter retransmission count), and can be roughly classified into HARQ Type I, HARQ Type II and HAR Type III, each of which will now be described.

1. HARQ Type I

A transmitter transmits frames in the same format at both initial transmission and retransmission. Herein, the frame refers to a frame coded with an error correction code. That is, when a receiver fails to normally receive the initially transmitted frame due to an error, the transmitter retransmits to the receiver the same frame that it initially transmitted.

Upon receiving a frame transmitted at the initial transmission of the transmitter, the receiver decodes the received frame and determines whether there is any error therein. If there is any error, the receiver transmits Negative Acknowledgement (NAK) information indicating abnormal receipt of the frame initially transmitted by the transmitter, to the transmitter to request retransmission of the corresponding frame. Thereafter, the receiver decodes a frame retransmitted from the transmitter in response to the retransmission request, independent of the frame initially transmitted by the transmitter.

With reference to FIG. 1, a description will now be made of an operation of retransmitting data according to HARQ Type I in a general communication system.

Referring to FIG. 1, a transmitter 100 transmits a frame #P to a receiver 150 in step 111. Then the receiver 150 receives the frame #P transmitted by the transmitter 100 in step 113, and determines in step 115 whether there is any error in the received frame #P. The receiver 150 can use the CRC code in determining whether there is any error in the received frame #P. If it is determined that there is an error in the received frame #P, the receiver 150 buffers the defective frame #P therein in step 117, and transmits NAK information for the frame #P to the transmitter 100 in step 119, to request retransmission of the frame #P. However, if there is no error in the received frame #P, the receiver 150 transmits Acknowledgement (ACK) information for the frame #P to the transmitter 100.

Upon receiving the NAK information for the frame #P from the receiver 150, the transmitter 100 retransmits the frame #P to the receiver 150 in step 121. Then the receiver 150 receives the frame #P retransmitted by the transmitter 100 in step 123, and soft-combines the defective frame #P buffered therein with the received frame #P in step 125. The receiver 150 determines in step 127 whether there is any error in the frame generated by soft-combining the defective frame #P buffered therein with the received frame #P. If it is determined that there is no error therein, the receiver 150 transmits ACK information for the frame #P to the transmitter 100 in step 129. Upon receiving the ACK information for the frame #P from the receiver 150, the transmitter 100 transmits the next frame #(P+1) to the receiver 150 in step 131. However, if there is an error in the frame generated by soft-combining the defective frame #P buffered therein with the received frame #P, the receiver 150 sends a retransmission request for the frame #P to the transmitter 100.

2. HARQ Type II

HARQ Type II is an HARQ scheme using Chase Combining (CC). In HARQ Type II, a transmitter transmits frames in the same format at both initial transmission and retransmission, a receiver soft-combines the frames transmitted by the transmitter at its initial transmission and retransmission, and decodes the soft-combined frame. The following is a detailed description thereof.

The frame in a HARQ Type II scheme refers to a frame coded with an error correction code. That is, when a receiver fails to normally receive the initially transmitted frame due to an error, the transmitter retransmits to the receiver the same frame that it transmitted at initial transmission.

Upon receiving a frame transmitted at the initial transmission of the transmitter, the receiver decodes the received frame and determines whether there is any error therein. If there is any error in the received frame, the receiver transmits NAK information indicating abnormal receipt of the frame initially transmitted by the transmitter, to the transmitter to request retransmission of the corresponding frame. Thereafter, the receiver soft-combines the frame retransmitted from the transmitter in response to the retransmission request with the frame initially transmitted by the transmitter, and decodes the soft-combined frame.

3. HARQ Type III

HARQ Type III is an HARQ scheme using Incremental Redundancy (IR). In HARQ Type III, a transmitter transmits frames in different formats at initial transmission and retransmission, and a receiver code-combines the frames transmitted by the transmitter at its initial transmission and retransmission, and decodes the code-combined frame. The following is a detailed description thereof.

When a receiver fails to normally receive the initially transmitted frame due to an error, the transmitter retransmits to the receiver a different frame from the frame that it initially transmitted. Herein, both the initially transmitted and the retransmitted frames are coded with an error correction code, and have different coding schemes.

Upon receiving a frame transmitted at the initial transmission of the transmitter, the receiver decodes the received frame and determines whether there is any error therein. If there is any error in the received frame, the receiver buffers the received frame, and transmits NAK information indicating abnormal receipt of the frame initially transmitted by the transmitter, to the transmitter to request retransmission of the corresponding frame. Thereafter, the receiver code-combines the frame retransmitted from the transmitter in response to the retransmission request with the frame initially transmitted by the transmitter, and decodes the code-combined frame.

HARQ Type III can be sub-classified into partial IR-based HARQ Type III and full IR-based HARQ Type III. In partial IR-based HARQ Type III, the frame transmitted at retransmission is partially different from the frame transmitted at initial transmission. In full IR-based HARQ Type III, the frame transmitted at retransmission is fully different from the frame transmitted at initial transmission. The full IR-based HARQ Type III can acquire maximum gain based on redundancy information, but cannot perform normal decoding with only the frame received during retransmission. However, the partial IR-based HARQ Type III can perform normal decoding with only a part of the frame received during retransmission, which is termed a “self-decodable characteristic.” As a result, among the three types of HARQ schemes, the IR-based HARQ Type III is optimal in terms of throughput.

Meanwhile, codes available for iterative decoding include turbo codes, serially concatenated codes and LDPC codes. It is known that the turbo code, which is a parallel concatenated code, is superior in performance gain to the convolutional code typically used for error correction during high-speed data transmission. The turbo code effectively corrects an error caused by noises generated in a transmission channel, thereby increasing data transmission reliability. In particular, as performance improvement of the turbo code has occurred based on the iterative decoding, various types of codes available for iterative decoding have been developed.

Compared with the turbo code that parallel concatenates convolutional codes using an interleaver, the serially concatenated code serially concatenates the convolutional codes using an interleaver, thereby solving the problem of the turbo code wherein an error floor occurs at a high signal-to-noise ratio (SNR).

A system available for iterative decoding includes a Bit Interleaved Coded Modulation (BICM) system. The BICM system interleaves convolutional codes using an interleaver and then modulates the interleaved convolutional codes using a modulation scheme with bandwidth efficiency of 1 or higher, such as 8-ary Phase Shift Keying (8PSK). The BICM system performs iterative decoding using prior information in the process of decoding a modulation constellation using a soft decision value of a received frame. Although the BICM system uses the convolutional codes in the foregoing description, it can also use the serially concatenated codes and the LDPC codes.

Performance of the BICM system is greatly affected by mapping in the constellation. A mapping design scheme recently developed by Frank Schreckenbach generates a random mapping table, and compares it with a criterion for performance evaluation to select an optimal mapping table corresponding to the performance evaluation criterion. The mapping design scheme is available for full search in a modulation scheme having fewer signal points, such as Quadrature Phase Shirt Keying (QPSK) and 8PSK, but is unavailable for the full search in a modulation scheme having a greater number of signal points, such as 16-ary or higher Quadrature Amplitude Modulation (QAM), due to its excessively wide search range. For example, the mapping design scheme, when it is applied to 16QAM modulation, should perform 16! searches.

When the full search is not possible, the mapping design scheme selects binary switch for minimizing a search metric value of a mapping table by a binary switch scheme from a randomly generated initial mapping table, and selects an optimal mapping table for minimizing a search metric value of the mapping table by iterating the binary switch scheme multiple times. When selecting the optimal mapping table according to the binary switch scheme, the mapping design scheme does not minimize the search metric value of the mapping table through the full search, but can select a locally optimized mapping table through fewer searches.

The search metric value represents an error event probability of a concatenated code. In a fading channel, such as a Rayleigh fading channel, the search metric D^{r} can be represented by Equation (1), and in an additive white Gaussian noise (AWGN) channel, the search metric D^{a} can be represented by Equation (2).

$$\begin{matrix}{D}^{r} = \frac{1}{q {2}^{q}} {\sum }_{i = 1}^{q} {\sum }_{b = 0}^{1} {\sum }_{{S}_{k} ∈ {X}_{b}^{i}} {\sum }_{{S}_{\overline{k}} ∈ {X}_{\overline{b}}^{i}} \frac{1}{{\vert {S}_{k} - {\hat{S}}_{k} \vert}^{2}} & ( 1 ) \\ {D}^{a} = \frac{1}{q {2}^{q}} {\sum }_{i = 1}^{q} {\sum }_{b = 0}^{1} {\sum }_{{S}_{k} ∈ {X}_{b}^{i}} {\sum }_{{S}_{\overline{k}} ∈ {X}_{\overline{b}}^{i}} exp ( - \frac{{E}_{s}}{4 {N}_{0}} {\vert {S}_{k} - {\hat{S}}_{k} \vert}^{2} ) & ( 2 )\end{matrix}$$

In Equation (1) and Equation (2), q denotes the number of expression bits for a modulation scheme. For example, q=2 for QPSK modulation and q=3 for 8PSK modulation. In addition, a variable b denotes a binary value, i.e., a value of 0 or 1, \overline{b} denotes a complementary number of the variable b, and Sₖ or Ŝₖ denotes a random signal point in X_{b}ⁱ or X_{\overline{b}}ⁱ.

In the AWGN channel environment, a Eₛ/N₀ value is required to calculate the search metric shown in Equation (2), and a target Eₛ/N₀ value in the corresponding system is used as the Eₛ/N₀ value. Herein, Eₛ denotes symbol energy and N₀ denotes noise power density.

As shown in Equation (1) and Equation (2), the search metric value represents bit-based error probability on the average concept. Equation (1) and Equation (2) can take into account the following two cases in determining whether to deliver the prior information.

In a first case, the prior information is fully delivered. In this case, information on the bits except for the bit position where a bit metric is found in the process of decoding a signal point by iterative decoding is fully known. This means that the number of iterations is set to a larger value during iterative decoding, and the number of signal points corresponding to X_{\overline{b}}ⁱ is 1.

In a second case, there is no prior information. In this case, decoding is performed without the prior information without consideration of the iterative decoding. This case corresponds to first iteration in the iterative decoding process, and the number of signal points corresponding to X_{\overline{b}}ⁱ is 2^{m}/2.

A description will now be made of an exemplary operation of the BICM system.

In calculating the search metric D^{r} on the assumption that the modulation scheme is set to 8PSK and a channel environment is a Rayleigh fading channel environment, for a first bit with b=0, the BICM system detects and sums up all reciprocals of squares of Euclidean distances for 4 signal points with b=1 of 100, 110, 101, 111 when there is no prior information. On the contrary, when there is prior information, for a first bit with b=0, the BICM system detects and sums up reciprocals of squares of Euclidean distances for a signal point of 100 if the prior information is ‘00’.

In order to prevent instability of communication due to fading, the mobile communication system uses diversity schemes. One type is a space diversity scheme, which uses multiple antennas. The space diversity scheme is classified into a receive antenna diversity scheme, a transmit antenna diversity scheme and a Multiple Input Multiple Output (MIMO) scheme, which also uses multiple reception antennas. The MIMO scheme, which is a Space-Time Coding (STC) scheme, transmits a signal coded with a coding scheme using a plurality of transmission antennas to extend a time-domain coding scheme to a space-domain coding scheme, thereby achieving a low error rate.

After a Space Time Block Code (STBC) and a Space Time Trellis Code (STTC) were proposed by Tarokh, active research has been being conducted to improve performance of a Space Time Code (STC). It has been proven by Tarokh that performance of an STTC depends on a minimum determinant value of a signal matrix, and Baro et al. discovered an optimal code by fully searching generation coefficients for the STTC structure.

In addition, Yan et al. searched a performance criterion for maximizing a determinant value on the average concept as well as taking the minimum determinant value into consideration, for a new code, and it is now known that a Yan code is an STTC that shows the maximum performance for the case where the number of reception antennas is 1.

Thereafter, it was known by Chen et al. that when the number of reception antennas is 2 or more, fading occurring in a channel is applied to multiple paths, so that as the number of the reception antennas increases, distortion caused by the channel is modeled as AWGN according to the central limit theorem and thus the performance criterion becomes a minimum squared Euclidean distance rather than the minimum determinant. A Chen code is known as an STTC that shows the maximum performance when the number of reception antennas is 2 or more.

Meanwhile, for a slow static fading channel environment in an STC system with n transmission antennas and m reception antennas, error probability and STC performance are determined based on the following criteria.

In STC, if a sequence (or STC matrix) transmitted through a channel is expressed as c and a sequence that can be wrongly decoded due to distortion of the channel for the sequence c is expressed as e, then the sequence c and the sequence e can be represented by Equation (3), as follows:

$$c = ( \begin{matrix}{c}_{1}^{1} , {c}_{2}^{1} , ⋯ , {c}_{1}^{1} \\ {c}_{1}^{2} , {c}_{2}^{2} , ⋯ , {c}_{1}^{2} \\ ⋯ \\ {c}_{1}^{n} , {c}_{n}^{2} , ⋯ , {c}_{1}^{n}\end{matrix} ) , e = ( \begin{matrix}{e}_{1}^{1} , {e}_{2}^{1} , ⋯ , {e}_{1}^{1} \\ {e}_{1}^{2} , {e}_{2}^{2} , ⋯ , {e}_{1}^{2} \\ ⋯ \\ {e}_{1}^{n} , {e}_{n}^{2} , ⋯ , {e}_{1}^{n}\end{matrix} ) \qquad ( 3 )$$

In Equation (3), the number of rows of each matrix represents the number of transmission antennas, and the number of columns of each matrix represents a length of codeword.

The error probability of the STC can be represented by Equation (4), as follows:

$$P ( c \to e ) \leq {( Det )}^{- m} {( \frac{{E}_{s}}{4 {N}_{0}} )}^{- rm} \qquad ( 4 )$$

In Equation (4), A=(c−e)(c−e)* denotes a signal matrix, r denotes a rank of the signal matrix A, Det denotes a determinant, and * denotes a transpose conjugate operation of the matrix.

As shown in Equation (4), in order to minimize the error probability of the STC, it is necessary to maximize a rank of the signal matrix A so that it equals the number of transmission antennas, and maximize the minimum determinant value of the signal matrix A.

The STC performance should be differentiated according to the number of reception antennas, because as the number of the reception antenna increases, distortion caused by the channel is modeled as AWGN according to the central limit theorem as described above. That is, because the channel environment is modeled as AWGN as the number of the reception antennas increases, the minimum squared Euclidean distance which is a performance criterion in the AWGN channel environment becomes an important factor for determining performance of the STC, compared with the minimum determinant. Herein, the minimum squared Euclidean distance is given as a trace of a signal matrix. In this case, the rank condition is mitigated, so it is allowed to be set to a value of at least 2 or above, without having to equal to the number of transmission antennas.

Since the minimum squared Euclidean distance was proven as a factor for determining STC performance as described above, active research into an STTC has been being conducted on the STC to increase the minimum squared Euclidean distance. Currently, research is being conducted on an STBC for maximizing the minimum determinant on the assumption that the minimum squared Euclidean distance is fixed. That is, to this point, no research has been conducted on STBC performance in terms of increasing the minimum squared Euclidean distance.

In addition, even considering the STBC-MIMO communication system using the HARQ scheme, the STBC performance is never taken into consideration in terms of the increase in the minimum squared Euclidean distance. Accordingly, there is a need for a scheme for improving the performance in terms of the increase in the minimum squared Euclidean distance for the STBC-MIMO communication system using the HARQ scheme.

### SUMMARY OF THE INVENTION

It is, therefore, an object of the present invention to provide an apparatus and method for retransmitting data while varying a signal point mapping rule for initial transmission and retransmission in an STBC-MIMO communication system using an HARQ scheme.

It is another object of the present invention to provide an apparatus and method for retransmitting data with a minimum squared Euclidean distance being maximized in an STBC-MIMO communication system using an HARQ scheme.

According to the present invention, there is provided an apparatus for transmitting data in a transmitter of a communication system. The apparatus includes a signal mapper for generating a transmission frame by signal-mapping information data according to a control signal, if there is information data to transmit to a receiver, a transmitter for transmitting the transmission frame to the receiver; and a controller for controlling the signal mapper to generate a first transmission frame by signal-mapping the information data according to a first signal point mapping rule, and upon detecting that the receiver fails to normally receive the first transmission frame, controlling the signal mapper to generate a second transmission frame by signal-mapping the information data according to a second signal point mapping rule preset such that a minimum squared Euclidean distance with the first transmission frame is maximized.

According to the present invention, there is provided an apparatus for transmitting data in a transmitter using a plurality of transmission antennas. The apparatus includes a signal mapper for modulating information data into modulation symbols according to a preset modulation scheme, if there is information data to transmit to a receiver, and signal-mapping the modulation symbols according to a control signal, a space-time block code (STBC) encoder for encoding the signal-mapped modulation symbols according to a preset STBC coding scheme to generate a transmission frame to be transmitted via the plurality of transmission antennas, a transmitter for transmitting the transmission frame to the receiver, and a controller for controlling the signal mapper to signal-map the modulation symbols according to a first signal point mapping rule, and upon detecting that the receiver fails to normally receive the first transmission frame, controlling the signal mapper to signal-map the modulation symbols according to a second signal point mapping rule preset such that a minimum squared Euclidean distance with the first transmission frame is maximized.

According to the present invention, there is provided an apparatus for receiving data in a receiver of a communication system. The apparatus includes a space-time block code (STBC) decoder for signal-demapping, upon receiving a frame, the received frame according to a signal point demapping rule matched to a signal point mapping rule used in a transmitter matched to the receiver depending on a control signal, and decoding the signal-demapped frame into information data, an error detector for detecting whether there is any error in the decoded information data, and a controller for controlling the signal point demapping rule to be applied to the received frame, and if there is any error in the decoded information data, sending to the transmitter a notification indicating a failure to normally receive the frame.

According to the present invention, there is provided an apparatus for receiving data in a receiver of a communication system including a transmitter with a plurality of transmission antennas and the receiver with a plurality of reception antennas. The apparatus includes a space-time block code (STBC) decoder for, upon a frame via the plurality of reception antennas, decoding the received frame according to an STBC decoding scheme matched to an STBC coding scheme used in the transmitter, demodulating the STBC-decoded signal according to a demodulation scheme matched with a modulation scheme used in the transmitter, signal-demapping the demodulated signal according to a signal point demapping rule matched to a signal point mapping rule used in the transmitter depending on a control signal, and decoding the signal-demapped signal into information data; an error detector for detecting whether there is any error in the decoded information data; and a controller for controlling the signal point demapping rule to be applied to the received frame, and if there is any error in the decoded information data, sending to the transmitter a notification indicating a failure to normally receive the frame.

According to the present invention, there is provided a method for transmitting data in a transmitter of a communication system. The method includes generating a first transmission frame by signal-mapping the information data according to a first signal point mapping rule if there is information data to transmit to a receiver, transmitting the first transmission frame to the receiver, generating a second transmission frame upon detecting that the receiver fails to normally receive the first transmission frame, by signal-mapping the information data according to a second signal point mapping rule preset such that a minimum squared Euclidean distance with the first transmission frame is maximized; and transmitting the second transmission frame to the receiver.

According to the present invention, there is provided a method for transmitting data in a transmitter using a plurality of transmission antennas. The method includes modulating information data into modulation symbols according to a preset modulation scheme if there is information data to transmit to a receiver, signal-mapping the modulation symbols according to a first signal point mapping rule, and encoding the signal-mapped modulation symbols according to a preset space-time block code (STBC) coding scheme to generate a first transmission frame to be transmitted via the plurality of transmission antennas, transmitting the first transmission frame to the receiver; upon detecting that the receiver fails to normally receive the first transmission frame, signal-mapping the modulation symbols according to a second signal point mapping rule preset such that a minimum squared Euclidean distance with the first transmission frame is maximized, and encoding the signal-mapped modulation symbols according to the STBC coding scheme to generate a second transmission frame to be transmitted via the plurality of transmission antennas, and transmitting the second transmission frame to the receiver.

According to the present invention, there is provided a method for receiving data in a receiver of a communication system. The method includes, upon receiving a frame, signal-demapping the received frame according to a signal point demapping rule matched to a signal point mapping rule used in a transmitter matched to the receiver, and decoding the signal-demapped frame into information data; and if there is any error in the decoded information data, sending to the transmitter a notification indicating a failure to normally receive the frame.

According to the present invention, there is provided a method for receiving data in a receiver of a communication system including a transmitter with a plurality of transmission antennas and the receiver with a plurality of reception antennas. The method includes decoding, upon receiving a frame via the plurality of reception antennas, the received frame according to a space-time block code (STBC) decoding scheme matched to an STBC coding scheme used in the transmitter, demodulating the STBC-decoded signal according to a demodulation scheme matched with a modulation scheme used in the transmitter, signal-demapping the demodulated signal according to a signal point demapping rule matched to a signal point mapping rule used in the transmitter, and decoding the signal-demapped signal into information data, and if there is any error in the decoded information data, sending to the transmitter a notification indicating a failure to normally receive the frame.

### BRIEF DESCRIPTION OF THE DRAWINGS

The above and other objects, features and advantages of the present invention will become more apparent from the following detailed description when taken in conjunction with the accompanying drawings in which:

FIG. 1 is a signal flow diagram illustrating an operation of retransmitting data according to HARQ Type I in a general communication system;

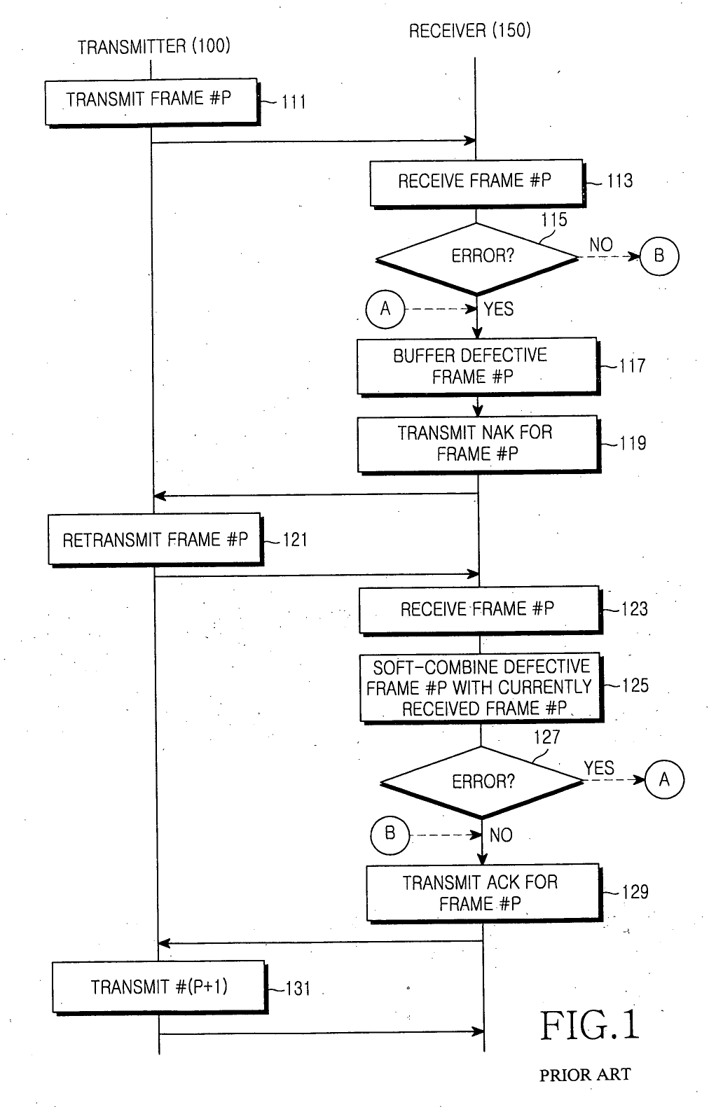

FIG. 2 is a block diagram illustrating a transmitter structure of an STBC-MIMO communication system using an HARQ scheme according to the present invention;

FIG. 3 is a block diagram illustrating a receiver structure of an STBC-MIMO communication system using an HARQ scheme according to the present invention;

FIG. 4 is a flowchart illustrating an operation of a transmitter of an STBC-MIMO communication system using an HARQ scheme according to the present invention;

FIG. 5 is a flowchart illustrating an operation of a receiver of an STBC-MIMO communication system using an HARQ scheme according to the present invention;

FIG. 6 is a signal flow diagram illustrating a data retransmission operation in an STBC-MIMO communication system using an HARQ scheme according to the present invention; and

FIG. 7 is a diagram schematically illustrating a signal point mapping rule for minimizing an error event probability in an STBC-MIMO communication system using an HARQ scheme according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

The present invention proposes an apparatus and method for retransmitting data in an STBC-MIMO communication system. In particular, the present invention proposes a data retransmission apparatus and method for maximizing a minimum squared Euclidean distance to maximize retransmission performance by varying a signal point mapping rule applied during initial transmission and retransmission in an STBC-MIMO communication system using a HARQ scheme.

Before a description of the present invention is given, the purpose of maximizing the minimum squared Euclidean distance in the present invention will now be given.

As a distance between signal points in which noises with the same level are included increases, it is possible to minimize the probability that the original signal point transmitted by the transmitter will be incorrectly determined as another signal point. In other words, when a distance between signal points that can be included in a signal point set has a minimum value, the error rate is maximized. Accordingly, it is possible to minimize the error rate by maximizing the minimum squared Euclidean distance. Therefore, maximizing the minimum squared Euclidean distance serves as an important factor for improving the entire signal transmission/reception performance.

Although the present invention will be described with reference to a data retransmission apparatus and method for a MIMO communication system using the STBC, the present invention can also be applied to a MIMO communication system using any code available for iterative decoding as well as the STBC.

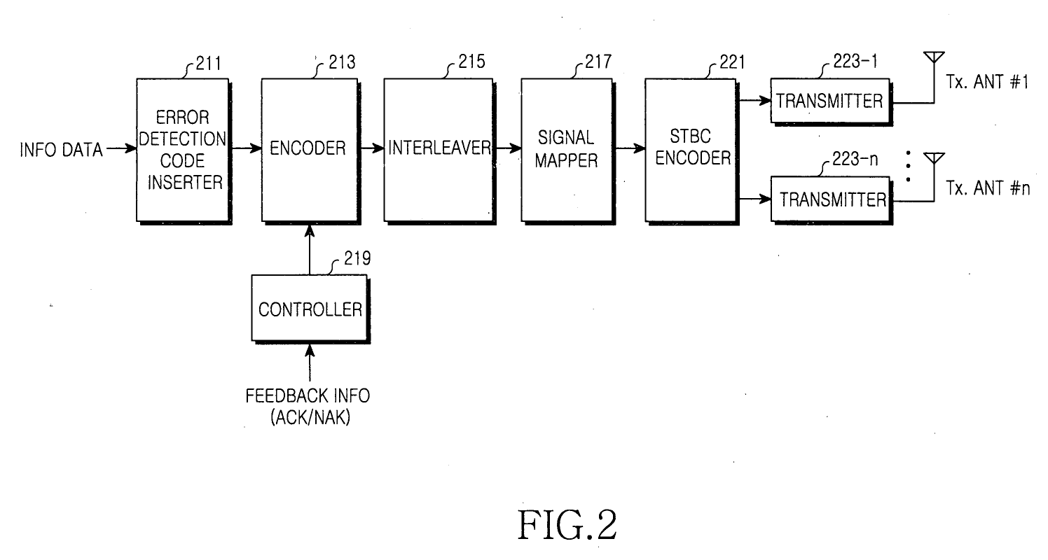

FIG. 2 is a block diagram illustrating a transmitter structure of an STBC-MIMO communication system using an HARQ scheme according to the present invention.

Referring to FIG. 2, the transmitter of the STBC-MIMO communication system includes an error detection code inserter 211, an encoder 213, an interleaver 215, a signal mapper 217, a controller 219, an STBC encoder 221 and a plurality of transmitters 223-1 through 223-n. Herein, the transmitters 223-1 through 223-n are connected to transmission antennas Tx.ANT#1 through Tx.ANT#n of the transmitter one to one.

Input information data is delivered to the error detection code inserter 211, and the error detection code inserter 211 inserts an error detection code in the information data, and provides its output to the encoder 213. Herein, the error detection code refers to a code used for detecting whether there is any error in a frame transmitted by the transmitter of the STBC-MIMO communication system, and can include, for example, a Cyclic Redundancy Check (CRC) code. The encoder 213 encodes the signal output from the error detection code inserter 211 into a coded bit stream using a preset coding scheme, and outputs the coded bit stream to the interleaver 215. Herein, the preset coding scheme refers to a coding scheme for generating a code available for iterative decoding, and the code available for iterative decoding includes a turbo code, a serially concatenated code and a low density parity check (LDPC) code.

The interleaver 215 interleaves the signal output from the encoder 213 using a preset interleaving scheme to prevent a burst error, and outputs the interleaved signal to the signal mapper 217. The signal mapper 217 generates modulation symbols by performing signal mapping on the signal output from the interleaver 215 according to a signal point mapping rule determined by the controller 219, and outputs the modulation symbols to the STBC encoder 221.

The controller 219 determines the signal point mapping rule to be used in the signal mapper 217 according to the number of transmissions (hereinafter transmission count) for a corresponding frame, and feedback information received over a feedback channel from a receiver of the STBC-MIMO communication system, which is matched to a transmitter of the STBC-MIMO communication system. Such feedback information indicates whether the receiver has normally received a frame transmitted by the transmitter of the STBC-MIMO communication system, for example, Acknowledgement (ACK) information indicating normal receipt of the frame or Negative Acknowledgement (NAK) information indicating failure to receive the frame. Herein, the transmission count refers to the number of transmissions for a corresponding frame. That is, the transmission count=1 indicates that the corresponding frame is initially transmitted, and the transmission count≧2 indicates the corresponding frame is retransmitted.

If the feedback information is ACK information, the controller 219 resets the transmission count to 1 and outputs the resultant transmission count to the signal mapper 217 so that the signal mapper 217 may perform signal mapping on the signal output from the interleaver 215 according to the signal point mapping rule used for initial transmission. Otherwise, if the feedback information is NAK information, the controller 219 increases the transmission count by 1 from the previous transmission count and outputs the resultant transmission count to the signal mapper 217 so that the signal mapper 217 may perform signal mapping on the signal output from the interleaver 215 according to the signal point mapping rule used for retransmission corresponding to the retransmission count.

An exemplary table for storing signal point mapping rules (constellation data) for initial transmission and retransmission, under the control of the controller 219, is shown in Table 1.

TABLE 1

| | Transmission Count | |
|---|---|---|
| Information bits | 1 (Initial Transmission) | 2 (Retransmission) |
| 00 | (0.7070, 0.7070) | (0.7070, 0.7070) |
| 01 | (−0.7070, 0.7070) | (−0.7070, −0.7070) |
| 10 | (−0.7070, −0.7070) | (−0.7070, 0.7070) |
| 11 | (0.7070, −0.7070) | (0.7070, −0.7070) |

In the STBC-MIMO communication system using the HARQ scheme, the optimal mapping table when QPSK is used as a modulation scheme is shown in Table 1. This means that when 00, 01, 10, 11 are transmitted at initial transmission, 00, 10, 01, 11 are transmitted at retransmission. A detailed description thereof will be given later.

The signal mapper 217 performs signal mapping on the signal output from the interleaver 215 according to the constellation based on transmission count output from the controller 219, and provides its output to the STBC encoder 221. According to the present invention, the transmitter sets a different constellation based on a preset modulation scheme used by the signal mapper 217, each time it retransmits a corresponding frame.

The modulation scheme used for the signal mapper 217 includes Binary Phase Shift Keying (BPSK) for mapping 1 bit (s=1) to one complex signal, Quadrature Phase Shift Keying (QPSK) for mapping 2 bits (s=2) to one complex signal, 8ary Quadrature Amplitude Modulation (8QAM) or 8ary Phase Shift Keying (8PSK) for mapping 3 bits (s=3) to one complex signal, and Quadrature Amplitude Modulation (16QAM) for mapping 4 bits (s=4) to one complex signal.

The STBC encoder 221 encodes the signal, i.e., the modulation symbols, output from the signal mapper 217 into an STBC code using a preset coding scheme, and outputs the STBC code to the transmitters 223-1 through 223-n. Each of the transmitters 223-1 through 223-n performs radio frequency (RF) processing on the coded symbols, i.e., a baseband complex signal, output from the STBC encoder 221, and transmits the RF-processed signal to the receiver of the STBC-MIMO communication system via its associated transmission antenna.

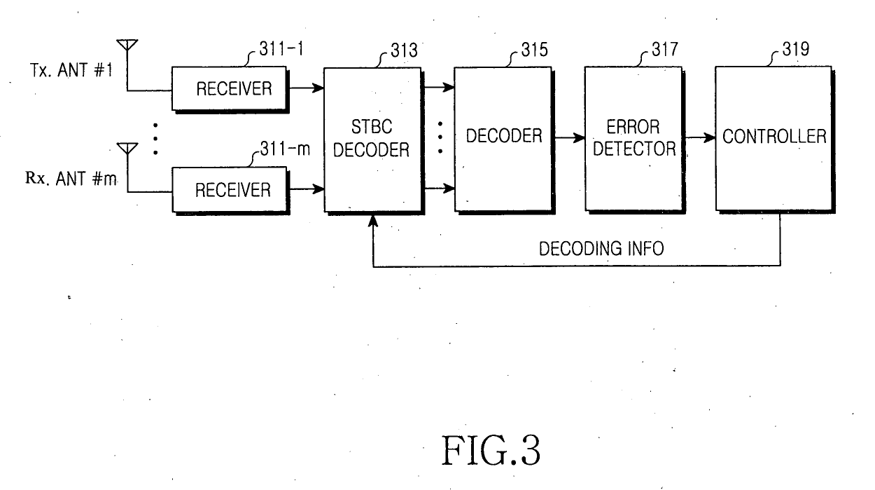

FIG. 3 is a block diagram illustrating a receiver structure of an STBC-MIMO communication system using an HARQ scheme according to the present invention.

Referring to FIG. 3, the receiver of the STBC-MIMO communication system includes a plurality of receivers 311-1 through 311-m, an STBC decoder 313, a decoder 315, an error detector 317 and a controller 319. Herein, the receivers 311-1 through 311-m are connected to reception antennas Tx.ANT#1 through Tx.ANT#m of the receiver one to one.

The signals transmitted by the transmitter of the STBC-MIMO communication system are received at the receiver of the STBC-MIMO communication system via the first through m^{th} reception antennas Rx.ANT#1 through Rx.ANT#m. The received signals experience a multipath channel during transmission and include noise components added thereto. The signals, that is, frames, received through the first through m^{th} reception antennas Rx.ANT#1 through Rx.ANT#m are delivered to their associated receivers. For example, the signal received via the first reception antenna Rx.ANT#1 is delivered to the first receiver 311-1, and in the same manner, the signal received via the m^{th} reception antenna Rx.ANT#m is delivered to the m^{th} receiver 311-m. Each of the receivers 311-1 through 311-m down-converts the signal received through its associated reception antenna into a baseband signal and analog-to-digital (A/D) converts the baseband signal through RF signal processing, and provides its output to the STBC decoder 313.

The STBC decoder 313 decodes the signals output from the receivers 311-1 through 311-m using an STBC decoding scheme corresponding to the STBC coding scheme used in the transmitter of the STBC-MIMO communication system, and outputs the decoded signals to the decoder 315. The controller 319 can detect the signal point mapping rule used in the transmitter of the STBC-MIMO communication system according to the transmission count for the signals output from the receivers 311-1 through 311-m. The controller 319 generates a signal point de-mapping rule matched to the detected signal point mapping rule as decoding information, and provides the decoding information to the STBC decoder 313. The STBC decoder 313 performs signal de-mapping on the STBC-coded signals according to the decoding information provided from the controller 319, and provides the signal de-mapping results to the decoder 315.

That is, the STBC decoder 313 acquires a reception vector from the signals output from the receivers 311-1 through 311-m, and calculates a soft decision value for all sequences transmittable from the transmitter of the STBC-MIMO communication system according to the transmission count, using the acquired reception vector. For example, assuming that 2 QPSK modulation symbols are transmitted via two transmission antennas at a particular time, the two QPSK modulation symbols are received via the first through m^{th} reception antennas after being added up in a wireless channel, and the signals received via the first through m^{th} reception antennas are delivered to their associated receivers in such a manner that the signal received via the first reception antenna is delivered to the first receiver 311-1. Accordingly, the signal receive via the m^{th} reception antenna is delivered to the m^{th} receiver 311-m.

The QPSK modulation symbol is comprised of 4 signal points. Therefore, it can be predicted that when 2 QPSK modulation symbols are added up, any one of 16×(4×4) signal points is received. Herein, one signal point is mapped to 4 information data bits. Therefore, the STBC decoder 313 estimates soft decision values for the signal points received at the receivers 311-1 through 311-m and the 16 reference signal points, and outputs the estimated soft decision values to the decoder 315.

The decoder 315 decodes the soft decision values output from the STBC decoder 313 using a decoding scheme matched to the coding scheme used in the transmitter of the STBC-MIMO communication system, and outputs the decoded soft decision values to the error detector 317. The signal output from the decoder 315 should be equal to the information data bits transmitted from the transmitter of the STBC-MIMO communication system, when the signal has no error caused by the wireless channel environment. However, because the signal has errors in the actual wireless channel environment, iterative decoding can be performed for reliable decoding.

The error detector 317 detects whether there is any error in the frame output from the decoder 315 through a CRC check operation, and outputs the error detection results to the controller 319. If the error detection result information output from the error detector 317 indicates occurrence of an error in the received frame, the controller 319 transmits NAK information to the transmitter of the STBC-MIMO communication system via a feedback channel (not shown) to request retransmission of the received frame. Otherwise, if the error detection result information output from the error detector 317 indicates non-occurrence of an error in the received frame, the controller 319 transmits ACK information to the transmitter of the STBC-MIMO communication system over the feedback channel to notify normal receipt of the received frame. In addition, the controller 319 provides decoding information for the received frame to the STBC decoder 313.

The transmitter of the STBC-MIMO communication system retransmits the corresponding frame (for NAK information) or transmits the successive frame (for ACK information) in response to the feedback information, i.e., ACK information or NAK information, received from the receiver of the STBC-MIMO communication system. In the process of retransmitting the corresponding frame, the transmitter of the STBC-MIMO communication system modifies the signal point mapping rule according to the transmission count for the corresponding frame so that it may retransmit the frame in a different format than the format transmitted at the previous transmission. Herein, the transmitter of the STBC-MIMO communication system maximizes the retransmission efficiency by modifying the signal point mapping rule such that the minimum squared Euclidean distance is maximized.

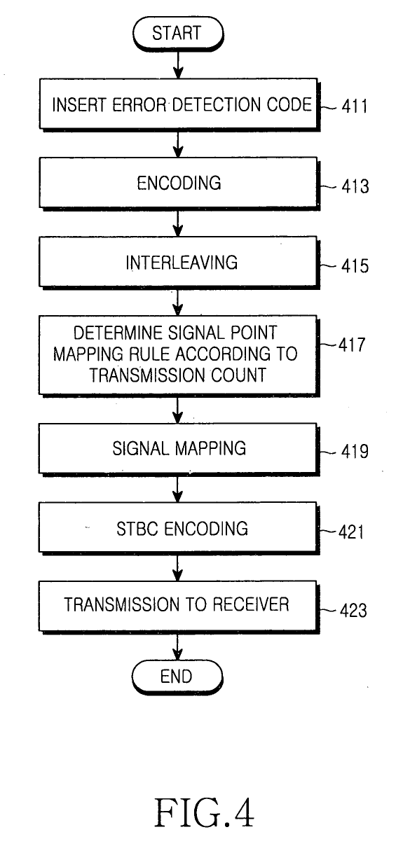

FIG. 4 is a flowchart illustrating an operation of a transmitter of an STBC-MIMO communication system using an HARQ scheme according to the present invention.

Referring to FIG. 4, if there is information data generated, the transmitter of the STBC-MIMO communication system inserts an error detection code, for example, CRC code, in the generated information data in step 411. The transmitter encodes in step 413 the error detection code-inserted information data using a preset coding scheme, for example, a coding scheme available for iterative decoding such as an LDPC coding scheme and a turbo coding scheme. The transmitter interleaves the coded bits according a preset interleaving scheme in step 415.

The transmitter determines a signal point mapping rule according to the transmission count in step 417. As described above, the purpose for variably determining the signal point mapping rule according to the transmission count is to increase retransmission efficiency by maximizing the minimum squared Euclidean distance. For example, when the transmitter uses the QPSK modulation in accordance with Table 1, the transmitter varies the signal point mapping rule such that it transmits 00, 10, 01, 11 at retransmission if it transmitted 00, 01, 10, 11 at initial transmission.

The transmitter generates modulation symbols in step 419 by performing signal mapping on the interleaved coded bits according to the determined signal point mapping rule. The transmitter STBC-encodes the modulation symbols according to a preset STBC coding scheme in step 421. The transmitter transmits the STBC-coded signal to a receiver via a plurality of transmission antennas in step 423, and then ends the operation.

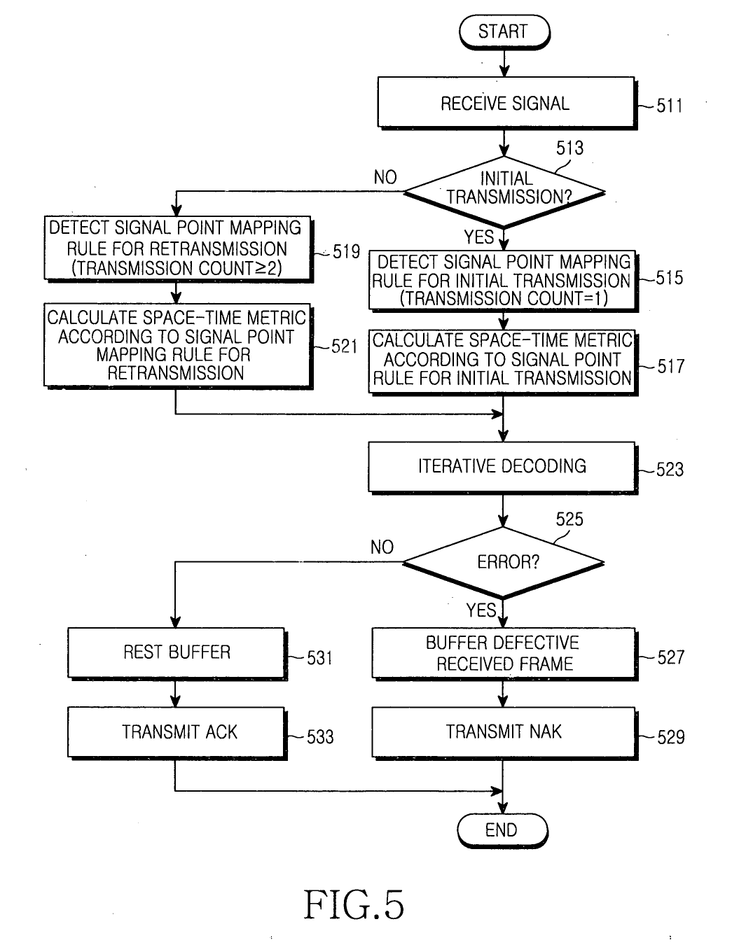

FIG. 5 is a flowchart illustrating an operation of a receiver of an STBC-MIMO communication system using an HARQ scheme according to the present invention.

Referring to FIG. 5, the receiver of the STBC-MIMO communication system receives signals via a plurality of reception antennas and performs RF processing on the received signal, i.e., received frame, in step 511. The receiver determines in step 513 whether the received frame is an initially transmitted frame. If it is determined that the received frame is an initially transmitted frame, the receiver proceeds to step 515 where it reads the signal point mapping rule used for initial transmission at the transmitter of the STBC-MIMO communication system, i.e., when the transmission count=1. The receiver detects in step 517 a space-time metric of the received frame according to the signal point mapping rule detected for the initial transmission.

However, if it is determined in step 513 that the received frame is not the initially transmitted frame, the receiver detects in step 519 a signal point mapping rule used for retransmission at the transmitter of the STBC-MIMO communication system, i.e., when the transmission count≧2, because the received frame is not the initially transmitted frame, i.e., is a retransmitted frame. In step 521, the receiver combines the previously received frame with the currently received frame and then calculates a space-time metric according to the signal point mapping rule for the retransmission.

The receiver performs iterative decoding according to the coding scheme used in the transmitter of the STBC-MIMO communication system in step 523. Herein, the iterative decoding continues until a preset iterative decoding stop condition is satisfied or the transmission count reaches the chosen number of iterations. The receiver determines in step 525 whether there is any error in the iterative-decoded received frame. If it is determined that there is any error in the iterative-decoded received frame, the receiver buffers the defective received frame in its buffer in step 527. Thereafter, in step 529, the receiver transmits NAK information to the transmitter of the STBC-MIMO communication system because of the error detected in the received frame, to request retransmission of the corresponding frame, and then ends the operation.

However, if it is determined in step 525 that there is no error in the iterative-decoded received frame, the receiver resets the buffer in step 531. Thereafter, in step 533, the receiver transmits ACK information to the transmitter of the STBC-MIMO communication system because of no error in the received frame, to request consecutive transmission of the successive frames, and then ends the operation.

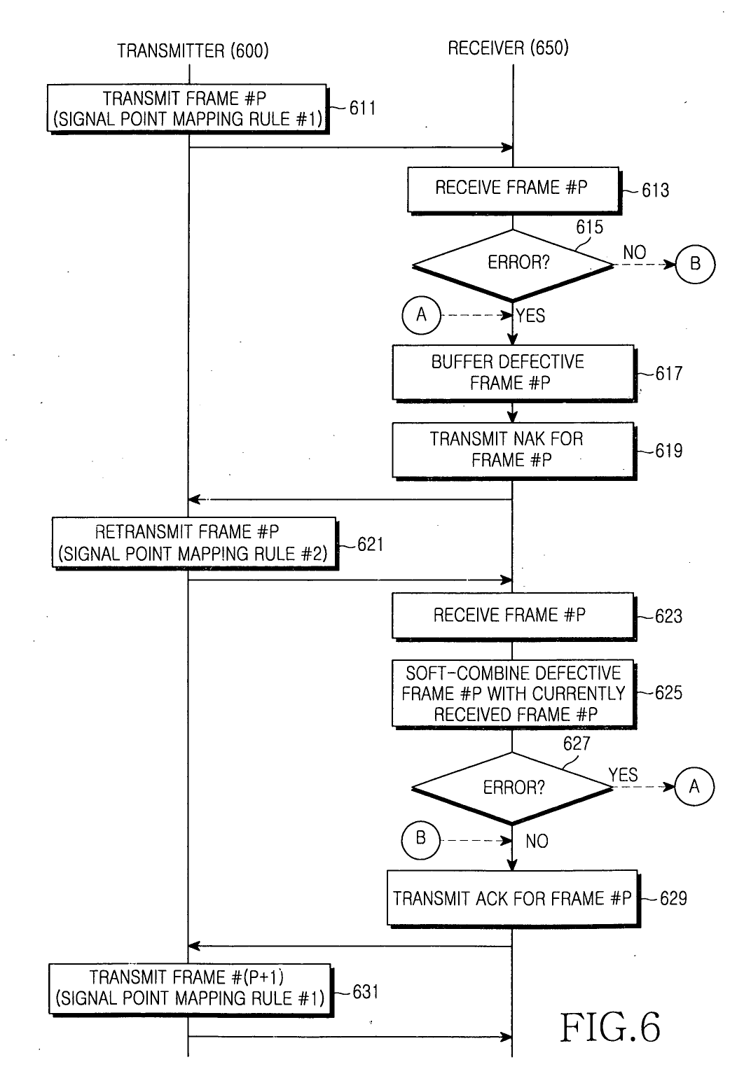

FIG. 6 is a signal flow diagram illustrating a data retransmission operation in an STBC-MIMO communication system using an HARQ scheme according to the present invention.

Referring to FIG. 6, a transmitter 600 of an STBC-MIMO communication system transmits a frame #P to a receiver 650 of the STBC-MIMO communication system in step 611. At this moment, the frame #P corresponds to a frame that was signal-mapped according to the transmission count=1, i.e., according to a signal point mapping rule for initial transmission, because it is an initially transmitted frame. Then the receiver 650 receives the frame #P transmitted by the transmitter 600 in step 613, and determines in step 615 whether there is any error in the received frame #P. As described above, the receiver 650 can use an error detection code such as a CRC code in determining whether there is any error in the received frame #P. If it is determined that there is any error in the received frame #P, the receiver 650 buffers the defective frame #P therein in step 617, and transmits NAK information for the frame #P to the transmitter 600 in step 619 to request retransmission of the frame #P. However, if there is no error in the received frame #P, the receiver 650 transmits ACK information for the frame #P to the transmitter 600.

Upon receiving the NAK information for the frame #P from the receiver 650, the transmitter 600 retransmits the frame #P in step 621. At this moment, the frame #P corresponds to a frame that was signal-mapped according to a signal point mapping rule for the transmission count≧2, because it is a retransmitted frame. The frame #P transmitted in step 621 is a frame that was signal-mapped using a signal point mapping rule for the transmission count=2.

Then the receiver 650 receives the frame #P retransmitted by the transmitter 600 in step 623, and soft-combines the defective frame #P buffered therein with the received frame #P in step 625. The receiver 650 determines in step 627 whether there is any error in the soft-combined frame #P. If it is determined that there is no error in the soft-combined frame #P, the receiver 650 transmits ACK information for the frame #P to the transmitter 600 in step 629. Upon receiving the ACK information for the frame #P from the receiver 650, the transmitter 600 transmits the next frame #(P+1) to the receiver 650 in step 631. At this moment, the frame #(P+1) also corresponds to a frame that was signal-mapped according to the transmission count=1, i.e., a signal point mapping rule for initial transmission, because it is an initially transmitted frame. However, if it is determined in step 627 that there is any error in the soft-combined frame, the receiver 650 sends a retransmission request for the frame #P to the transmitter 600.

Meanwhile, an error event probability D^{STBC} for a received symbol in the STBC-MIMO communication system using the HARQ scheme can be expressed as Equation (5), wherein the error event probability D^{STBC} represents a search metric for the STBC.

$${D}^{STBC} = \frac{1}{q {2}^{q}} {\sum }_{i = 1}^{q} {\sum }_{b = 0}^{1} {\sum }_{{S}_{k} ∈ {X}_{b}^{i}} {\sum }_{{S}_{\overline{k}} ∈ {X}_{\overline{b}}^{i}} {( {Det}_{single} )}^{- m} {( \frac{{E}_{s}}{4 {N}_{0}} )}^{- rm} \qquad ( 5 )$$

In Equation (5), q denotes the number of expression bits for a modulation scheme. For example, q=2 for QPSK modulation and q=3 for 8PSK modulation. In addition, a variable b denotes a binary value, i.e., a value of 0 or 1, \overline{b} denotes a complementary number of the variable b, and Sₖ or Ŝₖ denotes a random signal point in X_{b}ⁱ or X_{\overline{b}}ⁱ. Further, Eₛ denotes symbol energy, N₀ denotes noise power density, and Det_{signle} denotes a determinant value based on a single symbol in the STBC. Although the STBC is generated by combining a plurality of symbols, its signal point mapping scheme should be found from the average concept for a single symbol, so it will be assumed that a lot allocated for the other symbols except for the corresponding symbol is 0. In this case, therefore, a determinant value based on a single symbol becomes Det_{signle}.

The present invention uses the error event probability D^{STBC} for a received symbol, shown in Equation (5), as a criterion for searching for an optimal mapping table. For example, an Alamouti code is expressed by a 2×2 matrix, and a B=c−e matrix is

$$[ \begin{matrix}{x}_{1} - {x}_{1}^{′} & {x}_{2} - {x}_{2}^{′} \\ {x}_{2}^{*} - {x}_{2}^{* ′} & - ( {x}_{1}^{*} - {x}_{1}^{* ′} )\end{matrix} ] = [ \begin{matrix}Δ {x}_{1} & Δ {x}_{2} \\ Δ {x}_{2}^{*} & Δ {x}_{1}^{*}\end{matrix} ]$$

and an A matrix is BB*, so

$$[ \begin{matrix}Δ {x}_{1} & Δ {x}_{2} \\ Δ {x}_{2}^{*} & - Δ {x}_{1}^{*}\end{matrix} ] [ \begin{matrix}Δ {x}_{1}^{*} & Δ {x}_{2} \\ Δ {x}_{2}^{*} & - Δ {x}_{1}\end{matrix} ] = [ \begin{matrix}{\vert Δ {x}_{1} \vert}^{2} + {\vert Δ {x}_{2} \vert}^{2} & 0 \\ 0 & - {\vert Δ {x}_{1} \vert}^{2} + {\vert Δ {x}_{2} \vert}^{2}\end{matrix} ] .$$

Herein, Δ denotes a difference between symbols serving as errors. A determinant for this is given as (|Δx₁|²+|Δx₂|²)².

If one term of the determinant (|Δx₁|²+|Δx₂|²)² is assumed to be zero, then Det_{single}=(|Δx₁|²+|Δx₂|²)²=(|Δx₁|²+0)²=Δx₁⁴=Δx⁴. Thus, Equation (5) can be rewritten as Equation (6), as follows:

$${D}^{ALAMOUTI} = \frac{1}{q {2}^{q}} {\sum }_{i = 1}^{q} {\sum }_{b = 0}^{1} {\sum }_{{S}_{k} ∈ {X}_{b}^{i}} {\sum }_{{S}_{\overline{k}} ∈ {X}_{\overline{b}}^{i}} {\vert {S}_{k} - {\hat{S}}_{k} \vert}^{- 4 m} {( \frac{{E}_{s}}{4 {N}_{0}} )}^{- rm} \qquad ( 6 )$$

In Equation (6), D^{ALAMOUTI} denotes an error event probability for an Alamouti code. If the number of reception antennas is 1 and an influence of Eₛ/N₀ is not taken into consideration, Equation (6) can be expressed as the following Equation (7):

$${D}^{ALAMOUTI} = \frac{1}{q {2}^{q}} {\sum }_{i = 1}^{q} {\sum }_{b = 0}^{1} {\sum }_{{S}_{k} ∈ {X}_{b}^{i}} {\sum }_{{S}_{\overline{k}} ∈ {X}_{\overline{b}}^{i}} {( X )}^{- 4} \qquad ( 7 )$$

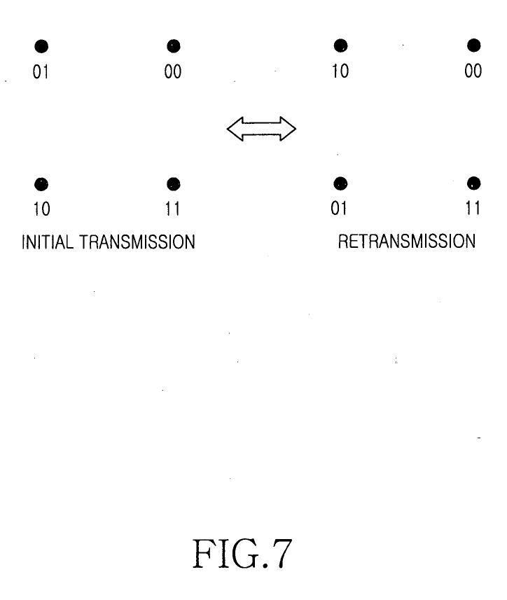

The optimal mapping table for minimizing the error event probability is shown in Table 1. With reference to FIG. 7, a description will now be made of a signal point mapping rule based on the mapping table shown in Table 1.

FIG. 7 is a diagram schematically illustrating a signal point mapping rule for minimizing an error event probability in an STBC-MIMO communication system using an HARQ scheme according to the present invention.

Referring to FIG. 7, in the STBC-MIMO communication system using the HARQ scheme, the mapping table optimized when QPSK modulation is used is shown in Table 1. Thus, when 00, 01, 10, 11 are transmitted at initial transmission, 00, 10, 01, 11 are transmitted at retransmission.

As can be understood from the foregoing description, the present invention proposes a signal point mapping rule for minimizing an error event probability in an STBC-MIMO communication system using an HARQ scheme, thereby contributing to maximization of retransmission efficiency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting data in a transmitter of a communication system, the method comprising the steps of:
generating a first transmission frame by signal-mapping information data according to a first signal point mapping rule when there is information data to transmit to a receiver;
transmitting the first transmission frame to the receiver;
generating a second transmission frame, upon detecting that the receiver fails to normally receive the first transmission frame, by signal-mapping the information data according to a second signal point mapping rule preset such that a minimum squared Euclidean distance with the first transmission frame is maximized; and
transmitting the second transmission frame to the receiver.

2. A method for transmitting data in a transmitter using a plurality of transmission antennas, the method comprising the steps of:
modulating information data into modulation symbols according to a preset modulation scheme when there is information data to transmit to a receiver;
signal-mapping the modulation symbols according to a first signal point mapping rule, and encoding the signal-mapped modulation symbols according to a preset space-time block code (STBC) coding scheme to generate a first transmission frame to be transmitted via the plurality of transmission antennas;
transmitting the first transmission frame to the receiver;
signal-mapping the modulation symbols, upon detecting that the receiver fails to normally receive the first transmission frame; according to a second signal point mapping rule preset such that a minimum squared Euclidean distance with the first transmission frame is maximized, and encoding the signal-mapped modulation symbols according to the STBC coding scheme to generate a second transmission frame to be transmitted via the plurality of transmission antennas; and
transmitting the second transmission frame to the receiver.

3. The method of claim 2, wherein when the modulation scheme is quadrature phase shift keying (QPSK), the first signal point mapping rule is determined such that the modulation symbols are signal-mapped to 00, 01, 10, 11 bits and the second signal point mapping rule is determined such that the modulation symbols are signal-mapped to 00, 10, 01, 11 bits.

4. An apparatus for transmitting data in a transmitter of a communication system, the apparatus comprising:
a signal mapper for generating a transmission frame by signal-mapping information data according to a control signal when there is information data to transmit to a receiver;
a transmitter for transmitting the transmission frame to the receiver; and
a controller for controlling the signal mapper to generate a first transmission frame by signal-mapping the information data according to a first signal point mapping rule, and upon detecting that the receiver fails to normally receive the first transmission frame, controlling the signal mapper to generate a second transmission frame by signal-mapping the information data according to a second signal point mapping rule preset such that a minimum squared Euclidean distance with the first transmission frame is maximized.

5. An apparatus for transmitting data in a transmitter using a plurality of transmission antennas, the apparatus comprising:
a signal mapper for modulating information data into modulation symbols according to a preset modulation scheme when there is information data to transmit to a receiver, and signal-mapping the modulation symbols according to a control signal;
a space-time block code (STBC) encoder for encoding the signal-mapped modulation symbols according to a preset STBC coding scheme to generate a transmission frame to be transmitted via the plurality of transmission antennas;
a transmitter for transmitting the transmission frame to the receiver; and
a controller for controlling the signal mapper to signal-map the modulation symbols according to a first signal point mapping rule, and upon detecting that the receiver fails to normally receive the first transmission frame, controlling the signal mapper to signal-map the modulation symbols according to a second signal point mapping rule preset such that a minimum squared Euclidean distance with the first transmission frame is maximized.

6. The apparatus of claim 5, wherein when the modulation scheme is quadrature phase shift keying (QPSK), the first signal point mapping rule is determined such that the modulation symbols are signal-mapped to 00, 01, 10, 11 bits and the second signal point mapping rule is determined such that the modulation symbols are signal-mapped to 00, 10, 01, 11 bits.

7. A method for receiving data in a receiver of a communication system, the method comprising the steps of:
signal-demapping, upon receiving a frame, the received frame according to a signal point demapping rule matched to a signal point mapping rule used in a transmitter matched to the receiver, and decoding the signal-demapped frame into information data; and
sending to the transmitter, if there is any error in the decoded information data, a notification indicating a failure to normally receive the frame.

8. The method of claim 7, wherein the signal point mapping rule is determined such that a minimum squared Euclidean distance between a previously transmitted frame and a currently transmitted frame is maximized.

9. A method for receiving data in a receiver of a communication system including a transmitter with a plurality of transmission antennas and the receiver with a plurality of reception antennas, the method comprising the steps of:
decoding, upon receiving a frame via the plurality of reception antennas, the received frame according to a space-time block code (STBC) decoding scheme matched to an STBC coding scheme used in the transmitter;
demodulating the STBC-decoded signal according to a demodulation scheme matched with a modulation scheme used in the transmitter, signal-demapping the demodulated signal according to a signal point demapping rule matched to a signal point mapping rule used in the transmitter, and decoding the signal-demapped signal into information data; and
sending to the transmitter, if there is any error in the decoded information data, a notification indicating a failure to normally receive the frame.

10. The method of claim 9, wherein the signal point mapping rule is determined such that a minimum squared Euclidean distance between a previously transmitted frame and a currently transmitted frame is maximized.

11. The method of claim 10, wherein when the modulation scheme is quadrature phase shift keying (QPSK), the signal point mapping rule is determined such that the modulation symbols are signal-mapped to 00, 01, 10, 11 bits in the previously transmitted frame and the modulation symbols are signal-mapped to 00, 10, 01, 11 bits in the currently transmitted frame.

12. An apparatus for receiving data in a receiver of a communication system, the apparatus comprising:
a space-time block code (STBC) decoder for, upon receiving a frame, signal-demapping the received frame according to a signal point demapping rule matched to a signal point mapping rule used in a transmitter matched to the receiver depending on a control signal, and decoding the signal-demapped frame into information data;
an error detector for detecting whether there is any error in the decoded information data; and
a controller for controlling the signal point demapping rule to be applied to the received frame, and if there is any error in the decoded information data, sending to the transmitter a notification indicating a failure to normally receive the frame.

13. The apparatus of claim 12, wherein the signal point mapping rule is determined such that a minimum squared Euclidean distance between a previously transmitted frame and a currently transmitted frame is maximized.

14. An apparatus for receiving data in a receiver of a communication system including a transmitter with a plurality of transmission antennas and the receiver with a plurality of reception antennas, the apparatus comprising:
a space-time block code (STBC) decoder for, upon a frame via the plurality of reception antennas, decoding the received frame according to an STBC decoding scheme matched to an STBC coding scheme used in the transmitter, demodulating the STBC-decoded signal according to a demodulation scheme matched with a modulation scheme used in the transmitter, signal-demapping the demodulated signal according to a signal point demapping rule matched to a signal point mapping rule used in the transmitter depending on a control signal, and decoding the signal-demapped signal into information data;
an error detector for detecting whether there is any error in the decoded information data; and
a controller for controlling the signal point demapping rule to be applied to the received frame, and if there is any error in the decoded information data, sending to the transmitter a notification indicating a failure to normally receive the frame.

15. The apparatus of claim 14, wherein the signal point mapping rule is determined such that a minimum squared Euclidean distance between a previously transmitted frame and a currently transmitted frame is maximized.

16. The apparatus of claim 15, wherein when the modulation scheme is quadrature phase shift keying (QPSK), the signal point mapping rule is determined such that the modulation symbols are signal-mapped to 00, 01, 10, 11 bits in the previously transmitted frame and the modulation symbols are signal-mapped to 00, 10, 01, 11 bits in the currently transmitted frame.
